(19) United States
(12) Patent Application Publication
(10) Pub. No.: US 2020/0033483 A1
(43) Pub. Date: Jan. 30, 2020

(54) Scintillator Panel and Method of Producing the Same

(71) Applicant: Konica Minolta, Inc., Tokyo (JP)

(72) Inventors: Tadashi ARIMOTO, Tokyo (JP); Hiromichi SHINDOU, Tokyo (JP)

(73) Assignee: Konica Minolta, Inc., Tokyo (JP)

(21) Appl. No.: 16/511,233

(22) Filed: Jul. 15, 2019

(30) Foreign Application Priority Data
Jul. 26, 2018 (JP) 2018-140130

(51) Int. Cl. G01T 1/20; B32B 27/14; B32B 27/16

(52) U.S. Cl. CPC G01T 1/2002; B32B 2307/40; B32B 27/16; B32B 27/14

(57) ABSTRACT

To provide a scintillator panel which is less likely to be influenced by film thickening, has high brightness and MTF, and has reduced noise.

A scintillator panel including a laminate in which a scintillator layer and a non-scintillator layer are repeatedly stacked in a direction substantially parallel to a radiation incident direction, wherein the laminate has an inclined structure in which a lamination angle of each layer in the laminate is changed in a sector shape and extrapolated surfaces of each layer intersect on a single line.

The present U. S. patent application claims priority under the Paris Convention and 35 U.S.C. § 119 to Japanese patent application No. 2018-140130 filed on Jul. 26, 2018, the entirety of which is incorporated herein by reference.

### BACKGROUND

### Technological Field

The present invention relates to a novel scintillator panel suitable for the Talbot system.

### Description of the Related art

Currently, in X-ray image diagnosis, an absorption image capturing attenuation of an X-ray after transmission through an object is used. Meanwhile, X-rays are one type of electromagnetic waves; therefore, in recent years, attention has been given to their wave nature, and attempts have been made to produce an image of a phase shift of an X-ray after transmission through an object. Such attenuation and phase shift are referred to as “absorption contrast” and “phase contrast”, respectively. An imaging technology utilizing this phase contrast has a higher sensitivity to light elements than a conventional technology utilizing absorption contrast and is thus believed to be highly sensitive to human soft tissues containing a large amount of light elements.

However, a conventional phase contrast imaging technology requires the use of a synchrotron X-ray source and a microfocus X-ray tube, and the former entails a large-scale facility while the latter cannot secure an X-ray dose sufficient for photographing a human body; therefore, it has been considered difficult to put such a conventional phase contrast imaging technology to practical use at general medical facilities.

In order to solve these problems, X-ray image diagnosis (Talbot system) which employs an X-ray Talbot-Lau interferometer that is capable of acquiring a phase contrast image with the use of an X-ray source conventionally used in medical practice is expected.

As illustrated in FIG. 5, a Talbot-Lau interferometer has a G0 lattice, a G1 lattice, and a G2 lattice that are each arranged between a medical X-ray tube and an FPD, and visualizes refraction of an X-ray caused by a subject as moiré fringes. An X-ray is irradiated in a longitudinal direction from an X-ray source arranged in an upper part, and the X-ray reaches an image detector through the G0 lattice, the subject, the G1 lattice, and the G2 lattice.

As a method of producing a lattice, for example, a method in which a silicon wafer having high X-ray transparency is etched to form lattice-form recesses and these recesses are subsequently filled with a heavy metal having excellent X-ray shielding properties is known.

However, in this method, it is difficult to increase the area due to, for example, the size of an available silicon wafer and restrictions on an etching device, and the imaging subject is thus limited to a small part. In addition, since not only it is not easy to form deep recesses on a silicon wafer by etching but also it is hard to evenly fill a metal into deep parts of the recesses, it is difficult to produce a lattice having a thickness enough to sufficiently shield X-rays. For this reason, particularly under high-voltage photographing conditions, a favorable image cannot be obtained due to transmission of X-rays through a lattice.

In view of the above, the scintillators, which are scintillators imparted with a lattice function and emit light in a lattice shape, are drawing attention.

For example, Applied Physics Letter 98, 171107 (2011) discloses a lattice-shaped scintillator in which a groove of a lattice manufactured by etching a silicon wafer is filled with a phosphor (CsI).

However, since the above method uses a silicon wafer like the method of manufacturing a G2 lattice described above, an area restriction and a situation in which film thickening is difficult, which are problems caused by the silicon wafer, have not been improved. In addition, there is also a new problem in that light emitted from CsI is attenuated while the light repeatedly collides with a wall surface of a silicon lattice, and brightness is reduced. Also, there is a problem in that under high-voltage photographing conditions, a favorable image cannot still be obtained due to transmission of X-rays through a lattice.

For this reason, emergence of a new scintillator allowing imaging of a thick subject without restriction on imaging portions has been desired.

Therefore, the present inventors have paid attention to a scintillator having a lattice shape, composed of a laminate of a scintillator layer and a non-scintillator layer. The scintillator having a lattice shape is configured such that an irradiated X-ray causes light to be emitted in the scintillator layer while the X-ray passes through the non-scintillator layer, and light emission is detected by a sensor, which the present applicant has proposed in WO2017/154261, JP-A 2017-223568, and JP-A 2017-227520.

Since a ray source that emits radiation such as an X ray is generally a point wave source, when each of the scintillator layer and the non-scintillator layer is formed completely in parallel, a phenomenon occurs in which a radiation is obliquely incident as it deviates from the center of the scintillator. As a result, so-called vignetting occurs, in which the radiation is not sufficiently transmitted at a scintillator end. Vignetting becomes a more serious problem as the area of the scintillator is increased.

### Description of Related Art

Patent Literature 1: WO2017/154261

Patent Literature 2: JP-A 2017-223568

Patent Literature 3: JP-A 2017-227520

### Non-Patent Literature

Non-Patent Literature 1: Applied Physics Letter 98, 171107 (2011)

### SUMMARY

An object of the present invention is to provide a scintillator in a lattice shape having small X-ray vignetting in a peripheral region.

To achieve the abovementioned object, a scintillator panel one aspect of the present invention includes; a scintillator panel including a laminate in which a scintillator layer and a non-scintillator layer are repeatedly laminated in a direction substantially parallel to a radiation incident direction, wherein the laminate has an inclined structure in which a lamination angle of each layer in the laminate is changed in a sector shape and extrapolated surfaces of each layer to a radiation source intersect on a single line.

To achieve the abovementioned object, a scintillator panel another aspect of the present invention includes; a method of producing a scintillator panel including a laminate in which a scintillator layer and a non-scintillator layer are repeatedly laminated in a direction substantially parallel to a radiation incident direction, wherein the laminate has an inclined structure in which a lamination angle of each layer in the laminate is changed in a sector shape and extrapolated surfaces of each layer to a radiation source intersect on a single line, the method including: repeatedly laminating the scintillator layer and the non-scintillator layer, and bending the laminate so that the lamination angle of each layer of the laminate is changed in a sector shape.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic view illustrating one mode of the scintillator panel according to the present invention;

FIG. 2 is a schematic structural view illustrating a method of producing a scintillator panel of the present invention;

FIG. 3 is a schematic structural view illustrating a Talbot scintillator including the scintillator panel according to the present invention;

FIG. 4 is a schematic view illustrating one mode combined with a photoelectric conversion element; and

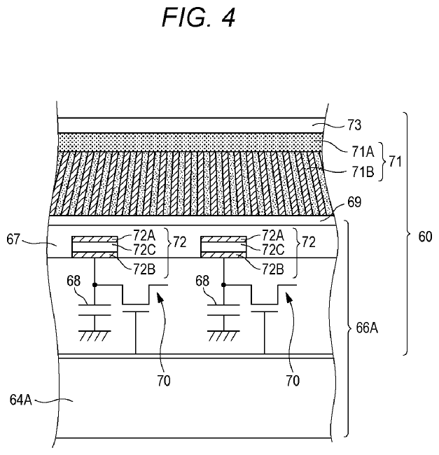

FIG. 5 is a schematic structural view illustrating a Talbot scintillator.

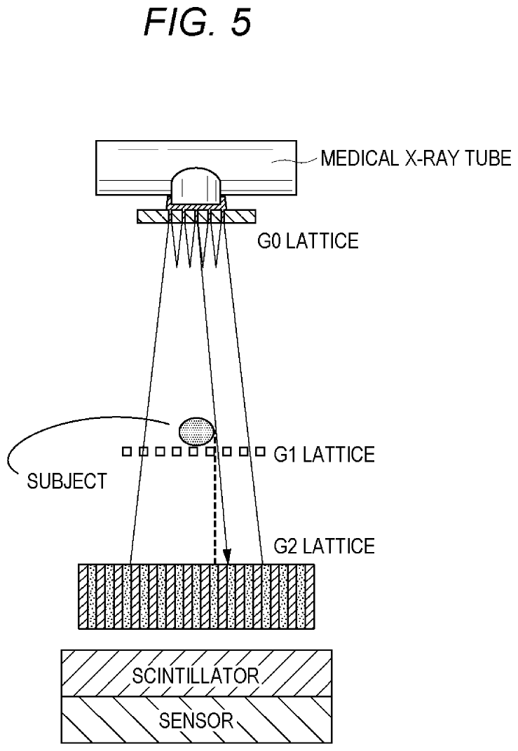

### DETAILED DESCRIPTION OF EMBODIMENTS

Hereinafter, one or more embodiments of the present invention will be described with reference to the drawings. However, the scope of the invention is not limited to the disclosed embodiments.

The scintillator panel of the present invention will now be described.

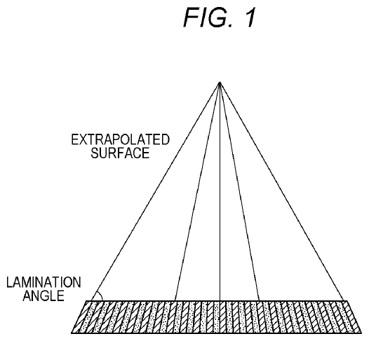

The scintillator panel according to the present invention includes a laminate in which a scintillator layer and a non-scintillator layer are repeatedly laminated in a direction substantially parallel to a radiation incident direction, wherein the laminate has an inclined structure in which a lamination angle of each layer in the laminate is changed in a sector shape and extrapolated surfaces of each layer intersect on a single line, as shown in FIG. 1. In the present invention, the scintillator having a lattice shape adopts a structure in which an inclination is increased toward the end, so as to have an inclined structure which is always parallel to a point wave source. For the scintillator having a lattice shape composed of only inorganic materials like Applied Physics Letter 98, 171107 (2011), inclination itself is difficult. Thus, in the present invention, in order to form an inclined structure, a scintillator having a lattice shape described in WO2017/154261, JP-A 2017-223568, and JP-A 2017-227520 is adopted, and an easily deformable organic material is used in a scintillator layer and a non-scintillator layer, thereby forming a predetermined inclined structure.

The light emitted by the scintillator as induced by a radiation can be converted into an electrical signal through a detector, whereby a digital image can be obtained. In the specification, “substantially parallel” refers to “almost parallel” and even the case in which there is a slight inclination is included in the category of “substantially parallel”. The present invention is a scintillator having a lattice shape including such a laminate.

As shown in FIG. 1, a cross-section of a radiation direction of the non-scintillator layer and the scintillator layer in the laminate is trapezoidal. “Extrapolation” in the present invention means connecting middle points between an upper surface and a lower surface of the trapezoid with straight lines, respectively and extending the straight lines to a radiation side.

A “sector shape” is a concentric circle and is extended to a shape surrounded by a radius and an arc at a predetermined central angle from the center, and in the present invention, the inside is cut off parallel to an arc portion and a string of the concentric circle, and the cross-section as the entire laminate is trapezoidal. A line which the extrapolated surface of each layer of the laminate intersects is the center of the concentric circle and an angle between a perpendicular line from the center to the laminate and the extrapolated surface is a lamination angle of each layer. The radiation source is positioned at the center of the concentric circle and the lamination angle is appropriately selected according to a distance from the radiation source to the scintillator laminate.

A thickness of a pair of the scintillator layer and the non-scintillator layer in a direction perpendicular to an incident direction, i.e., a thickness of the pair in the lamination direction (hereinafter, referred to as “lamination pitch”), and a thickness ratio of the scintillator layer and the non-scintillator layer in the lamination direction (hereinafter, referred to as “duty ratio”) are derived from Talbot interference conditions; however, generally speaking, the lamination pitch is preferably 0.5 to 50 μm, and the duty ratio is preferably 30/70 to 70/30. In order to acquire a diagnostic image with a sufficient area, the number of layers repeatedly laminated at such a lamination pitch is preferably 1,000 to 500,000.

A thickness of the laminate composed of the scintillator layer and the non-scintillator layer which constitutes the scintillator panel according to the present invention in the direction of the radiation source is not particularly limited, but may be about 50 to 2,000 82 m. When the thickness is smaller than the lower limit value of the above range, a light emission intensity of the scintillator is weak such that image quality is reduced. Further, when the thickness is larger than the upper limit value of the above range, a distance at which light emitted from the scintillator reaches the photoelectric conversion panel is long such that light is easily diffused and sharpness is reduced. Therefore, the thickness is appropriately selected according to the purpose.

Laminate

A scintillator layer constituting the laminate is a layer containing a scintillator as a main component and it is preferred to contain scintillator particles.

Scintillator Layer

As a material constituting the scintillator layer, a substance capable of converting radiation such as an X-ray to light having a different wavelength such as visible light can be used as appropriate. Specifically, for example, those scintillators and phosphors that are described on pages 284 to 299 of “Phosphor Handbook” (edited by Phosphor Research Society, Ohmsha Ltd., 1987) and the substances listed on the website “Scintillation Properties (http://scintillator.lbl.gov/)” of the US Lawrence Berkeley National Laboratory are considered, and even a substance that is not mentioned therein can be used as the scintillator as long as it is a “substance capable of converting radiation, such as an X-ray, into light having a different wavelength”.

Examples of the composition of the materials constituting the scintillator include the following. First, a metal halide-based phosphor represented by the following basic Composition Formula (I) can be mentioned:

M_{I}X.aM_{II}X′₂.bM_{III}X″₃:zA (I)

In the above basic Composition Formula (I), M_{I} represents at least one selected from the group consisting of elements that can be monovalent cations, i.e., lithium (Li), sodium (Na), potassium (K), rubidium (Rb), cesium (Cs), thallium (Tl), silver (Ag), and the like.

M_{II} represents at least one selected from the group consisting of elements that can be divalent cations, i.e., beryllium (Be), magnesium (Mg), calcium (Ca), strontium (Sr), barium (Ba), nickel (Ni), copper (Cu), zinc (Zn), cadmium (Cd), and the like.

M_{III} represents at least one selected from the group consisting of scandium (Sc), yttrium (Y), aluminum (Al), gallium (Ga), indium (In), and elements belonging to a lanthanoid.

X, X′, and X″ each represent a halogen element and may be different elements or the same element.

A represents at least one element selected from the group consisting of Y, Ce, Pr, Nd, Sm, Eu, Gd, Tb, Dy, Ho, Er, Tm, Yb, Lu, Na, Mg, Cu, Ag, Tl, and Bi (bismuth).

a, b and z each independently represent a numerical value in the respective ranges of 0a<0.5, 0b<0.5, and 0<z<1.0.

Further, a rare earth-activated metal fluorohalide phosphor represented by the following basic Composition Formula (II) can be mentioned as well:

M_{II}FX:zLn (II)

In the above basic Composition Formula (II), M_{II} represents at least one alkaline earth metal element, Ln represents at least one element belonging to a lanthanoid, X represents at least one halogen element, and z satisfies 0<z<0.2.

Further, a rare earth oxysulfide phosphor represented by the following basic Composition Formula (III) can be mentioned:

Ln₂O₂S:zA (III)

In the above basic Composition Formula (III), Ln represents at least one element belonging to a lanthanoid, A represents at least one element selected from the group consisting of Y, Ce, Pr, Nd, Sm, Eu, Gd, Tb, Dy, Ho, Er, Tm, Yb, Lu, Na, Mg, Cu, Ag, Tl and Bi, and z satisfies 0<z<1.

Further, a metal sulfide phosphor represented by the following basic Composition Formula (IV) can be mentioned:

M_{II}S:zA (IV)

In the above basic Composition Formula (IV), M_{II} represents at least one selected from the group consisting of elements that can be divalent cations, i.e., alkaline earth metals, Zn, Sr (strontium), and Ga, A represents at least one element selected from the group consisting of Y, Ce, Pr, Nd, Sm, Eu, Gd, Tb, Dy, Ho, Er, Tm, Yb, Lu, Na, Mg, Cu, Ag, Tl, and Bi, and z satisfies 0<z<1.

Further, a metal oxoacid salt phosphor represented by the following basic Composition Formula (V) can be mentioned:

M_{IIa}(AG)_{b}:zA (V)

In the above basic Composition Formula (V), M_{II} represents a metal element that can be a cation, (AG) represents at least one oxoacid group selected from the group consisting of phosphates, borates, silicates, sulfates, tungstates and aluminates, and A represents at least one element selected from the group consisting of Y, Ce, Pr, Nd, Sm, Eu, Gd, Tb, Dy, Ho, Er, Tm, Yb, Lu, Na, Mg, Cu, Ag, Tl, and Bi.

Further, a and b each represent any value that can be taken in accordance with the valence of the metal and that of the oxoacid group, and z satisfies 0<z<1.

Moreover, a metal oxide phosphor represented by the following basic Composition Formula (VI) can be mentioned:

MₐO_{b}:zA (VI)

In the above basic Composition Formula (VI), M represents at least one selected from metal elements that can be cations, and particularly preferably a metal belonging to a lanthanoid. Specific examples thereof include Gd₂O₃, Lu₂O₃, and the like.

A represents at least one element selected from the group consisting of Y, Ce, Pr, Nd, Sm, Eu, Gd, Tb, Dy, Ho, Er, Tm, Yb, Lu, Na, Mg, Cu, Ag, Tl, and Bi, and particularly preferably a metal belonging to a lanthanoid. As a specific example, a and b each represent any value that can be taken in accordance with the valence of the metal and that of the oxoacid group, and z satisfies 0<z<1.

In addition to the above, a metal acid halide phosphor represented by the following basic Composition Formula (VII) can be mentioned:

LnOX:zA (VII)

In the above basic Composition Formula (VII), Ln represents at least one element belonging to a lanthanoid, X represents at least one halogen element, A represents at least one element selected from the group consisting of Y, Ce, Pr, Nd, Sm, Eu, Gd, Tb, Dy, Ho, Er, Tm, Yb, Lu, Na, Mg, Cu, Ag, Tl, and Bi, and z satisfies 0<z<1.

In the present invention, it is preferred that the scintillator layer contains one or more types of phosphors having at least Gd₂O₂S, CsI, GdAlO₃, NaI, CsBr, La₂O₂S, Y₂O₂S, Lu₂O₃ as a matrix.

An average particle size of the scintillator particles is selected in accordance with the thickness of the scintillator layer, and is preferably 150% or less, more preferably 100% or less, and still more preferably 80% or less with respect to the thickness of the scintillator layer. When the average particle size of the scintillator particles exceeds the above range, the all scintillator particles cannot be put in the scintillator layer, and a laminated structure is disturbed, so that a Talbot interference function is reduced.

It is preferred that the scintillator layer contains an adhesive resin as a binder. Further, it is preferred that the adhesive resin is a material transparent to the emission wavelength of the scintillator so as not to inhibit the propagation of light emitted from the scintillator.

The adhesive resin is not particularly restricted as long as it does not adversely affect the object of the present invention, and examples thereof include natural polymeric substances, such as proteins including gelatin, polysaccharides including dextran, and gum Arabic; and synthetic polymeric substances, such as polyvinyl butyrals, polyvinyl acetates, ethylene-vinyl acetate copolymers, nitrocellulose, ethylcellulose, vinylidene chloride-vinyl chloride copolymers, poly(meth)acrylates, vinyl chloride-vinyl acetate copolymers, polyurethanes, cellulose acetate butyrate, polyvinyl alcohols, polyesters, epoxy resins, polyolefin resins, and polyamide resins. These resins may be cross-linked using a crosslinking agent such as an epoxy or an isocyanate, and these adhesive resins may be used alone or in combination of two or more thereof. The adhesive resin may be a thermoplastic resin or a thermosetting resin.

In the present invention, it is preferred that at least one of the scintillator layer and the non-scintillator layer contains an organic material having a modulus of elasticity less than 10 GPa, and for example, when the scintillator layer contains the organic material, the adhesive resin used as the binder corresponds to the organic material.

A content of the adhesive resin in the scintillator layer is preferably 1 to 80 vol %, more preferably 5 to 70 vol %, and still more preferably 10 to 60 vol %. When the content is lower than the lower limit value of this range, sufficient adhesiveness cannot be attained, whereas when the content is higher than the upper limit value of this range, brightness is reduced due to insufficient scintillator particle content.

As a method of forming the scintillator layer, the surface of the non-scintillator layer may be coated with a composition in which the scintillator particles and the adhesive resin are dissolved or dispersed in a, or a composition produced by heating and melting a mixture containing the scintillator particles and the adhesive resin may be coated on the surface of the non-scintillator layer. Furthermore, it is possible to use a method of using various vapor deposition methods to form the scintillator layer, transferring a separately manufactured scintillator layer, and the like.

In the case of coating a composition in which the above-described scintillator particles and adhesive resin are dissolved or dispersed in a solvent, examples of a solvent that can be used include lower alcohols, such as methanol, ethanol, isopropanol, and n-butanol; ketones, such as acetone, methyl ethyl ketone, methyl isobutyl ketone, and cyclohexanone; aromatic compounds, such as toluene, benzene, cyclohexane, cyclohexanone, and xylene; esters formed by a lower fatty acid and a lower alcohol, such as methyl acetate, ethyl acetate, and n-butyl acetate; ethers, such as dioxane, ethylene glycol monoethyl ether, ethylene glycol monomethyl ether, methoxypropanol propylene glycol monomethyl ether, and propylene glycol monomethyl ether acetate; halogenated hydrocarbons, such as benzenetriol, methylene chloride, and ethylene chloride; and mixtures thereof. In the composition, a variety of additives, such as a dispersant for improving the dispersibility of the scintillator particles in the composition, and a curing agent or a plasticizer for improving the bonding force between the adhesive resin and the scintillator particles in the resulting scintillator layer, may be mixed.

Examples of the dispersant include phthalic acid, stearic acid, caproic acid, a lipophilic surfactant, and the like. As the curing agent, those known as a curing agent of a thermoplastic resin and a thermosetting resin can be used.

In the case of heat-melting and coating a mixture containing the above-described scintillator particles and adhesive resin, it is preferred to use a hot-melt resin as the adhesive resin. As the hot-melt resin, for example, resins containing a polyolefin-based, polyamide-based, polyester-based, polyurethane-based, or acrylic resin as a main component can be used. Among such resins, from the standpoints of optical transparency, moisture resistance and adhesiveness, one containing a polyolefin-based resin as a main component is preferred. As the polyolefin-based resin, for example, an ethylene-vinyl acetate copolymer (EVA), an ethylene-acrylic acid copolymer (EAA), an ethylene-acrylate copolymer (EMA), an ethylene-methacrylate copolymer (EMAA), an ethylene-methacrylate ester copolymer (EMMA), an ionomer resin, or the like can be used. These resins may be used in the form of a so-called polymer blend in which two or more resins are combined.

Means for coating the composition for the formation of a scintillator layer is not particularly restricted, and ordinary coating means such as a doctor blade, a roll coater, a knife coater, an extrusion coater, a die coater, a gravure coater, a lip coater, a capillary coater, or a bar coater, or a commonly-used method such as dipping, spraying, or spinning can be employed.

Non-Scintillator Layer

The non-scintillator layer in the present invention is a layer which does not contain the scintillator as a main component, and a content of the scintillator in the non-scintillator layer is less than 10 vol %, preferably less than 1 vol %, and most preferably 0 vol %.

As the non-scintillator layer, it is possible to employ those containing glasses, polymer materials, metals, and the like as a main component. In the present invention, since it is preferred that at least one of the scintillator layer and the non-scintillator layer contains an organic material having a modulus of elasticity less than 10 GPa, when the scintillator layer contains the organic material, the materials constituting the non-scintillator layer is not particularly limited. The non-scintillator layer may be used as a single layer or may be used as a composite by combining a plurality of layers.

Specifically, the following can be used:

place glasses, such as quartz, a borosilicate glass, and a chemically reinforced glass; ceramics, such as sapphire, silicon nitride, and silicon carbide;

semiconductors, such as silicon, germanium, gallium arsenide, gallium phosphide, and gallium nitride;

polymers, for example, polyester such as polyethylene terephthalate (PET) and polyethylene naphthalate (PEN), aliphatic polyamides such as nylon, aromatic polyamides (aramid), polyimides, polyamide imides, polyether imides, polyethylenes, polypropylenes, polycarbonates, triacetates, cellulose acetate, epoxy, bismaleimide, polylactic acids, sulfur-containing polymers such as polyphenylene sulfides and polyether sulfones, polyether ether ketones, fluororesins, acrylic resins, and polyurethanes;

carbon fibers and glass fibers (particularly, fiber-reinforced resin sheets containing such fibers);

metal foil, such as aluminum, iron, and copper;

bionanofibers containing chitosan or cellulose; and the like.

The modulus of elasticity of the polymer materials represented as an example is generally less than 10 GPa.

The non-scintillator layer may be optically transparent or optically non-transparent, but preferably optically transparent. When the non-scintillator layer is optically non-transparent, light emitted from the scintillator is absorbed by the non-scintillator layer, whereby the brightness is reduced. On the other hand, when the non-scintillator layer is optically transparent, light absorption hardly occurs, whereby the brightness is improved.

The laminate constituting the scintillator of the present invention is produced by laminating the scintillator layer and the non-scintillator layer and bonding the scintillator layer and the non-scintillator layer. In the present invention, bonding refers to adhering the scintillator layer and the non-scintillator layer to be integrated. As a bonding method, both the scintillator layer and the non-scintillator layer may be adhered to each other through an adhesive layer, but it is preferred that the adhesive resin is previously contained in the scintillator layer or the non-scintillator layer and both are closely adhered to each other by pressure, so as to be bonded without the adhesive layer, from the standpoints of process simplification. Further, by heating in a pressurized state, a substance having an adhesion property is melted or cured, so that adhesion is strong, and thus, the above method is more preferred. Further, it is also possible to coat the surface of the non-scintillator layer with the composition capable of forming the scintillator layer as described above, thereby bonding the scintillator layer and the non-scintillator layer.

Manufacture of Laminated Scintillator Panel

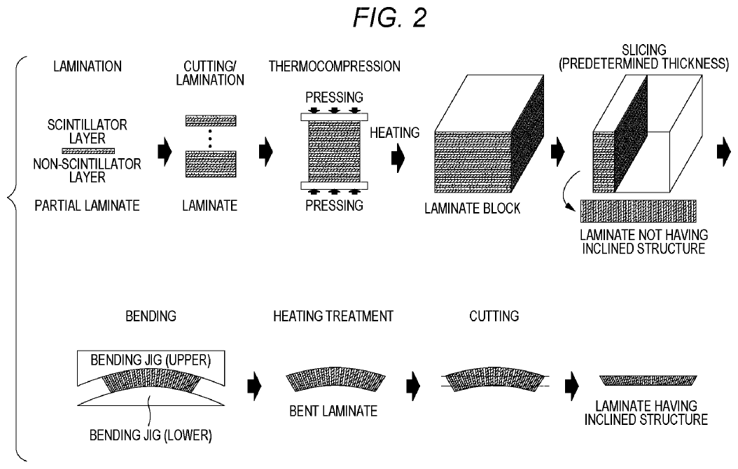

An example of the production method according to the present invention will be described with reference to FIG. 2.

The laminated scintillator having a lattice shape of the present invention is manufactured by repeatedly laminating the scintillator layer and the non-scintillator layer and bonding each adjacent layer.

A method of repeatedly laminating the scintillator layer and the non-scintillator layer is not particularly restricted, but for example, the scintillator layer and the non-scintillator layer may be alternately repeatedly laminated. In the present invention, as shown in FIG. 2, it is preferred that after a plurality of partial laminates in which the scintillator layer and the non-scintillator layer are previously bonded are created, the plurality of partial laminates are further laminated to form the laminate, from the standpoints of efficiency.

For example, lamination may be performed by repeatedly laminating and cutting the partial laminate composed of a pair of the scintillator layer and the non-scintillator layer in advance.

When the partial laminate composed of the scintillator layer and the non-scintillator layer has a film shape capable of being wound, efficient lamination is possible by winding the partial laminate on a core. The winding core may be cylindrical or flat.

A method of forming the partial laminate composed of the scintillator layer and the non-scintillator layer is not particularly restricted, but a polymer film may be selected as the non-scintillator layer and one surface thereof may be coated with a composition containing the scintillator particles and the adhesive resin, thereby forming the scintillator layer. Further, both surfaces of the polymer film may be coated with the composition containing the scintillator particles and the adhesive resin.

As described above, when the partial laminate is formed by coating the composition containing the scintillator particles and the adhesive resin on a polymer film, it is easy to divide the partial laminate into a plurality of sheets, in addition to process simplification. A division method is not particularly restricted, but a common cutting method is selected.

Further, a transfer base material on which the scintillator layer is previously applied may be transferred onto a film composed of the non-scintillator layer. The transfer base material is detached by means such as peeling, if required.

In the present invention, the laminate is pressurized so that the scintillator layer and the non-scintillator layer are arranged in parallel, thereby bonding the scintillator layer and the non-scintillator layer.

In order to adjust a lamination pitch to a desired value, a repeated laminate composed of a plurality of scintillator layers and non-scintillator layers may be thermally compressed, that is, heated in a pressurized state, so as to have desired dimensions. At this time, it is necessary to apply pressure perpendicularly to the lamination direction so that the lamination structure is not inclined.

A method of pressurizing the repeated laminate of a plurality of scintillator layers and non-scintillator layers so as to allow the repeated laminate to have desired dimensions is not particularly restricted; however, it is preferred to perform the pressurization with a spacer made of, for example, a metal being arranged in advance so that the laminate is not compressed further than the desired dimensions. The pressure applied in this process is preferably 1 MPa to 10 GPa. When the pressure is less than the lower limit value of this range, a resin component contained in the laminate may not be deformed into prescribed dimensions. When the pressure is higher than the upper limit value of this range, the spacer may be deformed, potentially causing the laminate to be compressed further than the desired dimensions.

When the laminate is thermally compressed, that is, heated in a pressurized state, the laminate can be more firmly bonded by binding of the scintillator layer and the non-scintillator layer in the laminate. As a heating condition, depending on the type of resin, it is preferred to heat the thermoplastic resin at the glass transition temperature or higher and the thermosetting resin at a curing temperature or higher, for about 0.5 to 24 hours for both cases. Generally, the heating temperature is preferably 40° C. to 250° C. A method of heating the laminate under pressure is not particularly restricted, but a press machine equipped with a heating element may be used or the laminate may be oven-heated in a state of being confined in a box-shaped jig such that the resulting laminate has prescribed dimensions, or a heating element may be mounted on the box-shaped jig.

As for the state of the laminate prior to the pressurization, it is preferred that voids exist inside the scintillator layers, inside the non-scintillator layers, or at the interfaces between the scintillator layers and the non-scintillator layers. When the pressurization is performed in the complete absence of such voids, a constituent material may partially flow out from an end surface of the laminate to cause disruption in the lamination pitch, or may cause the laminate to return back to the original dimensions once the pressure is released. With such voids being present, the voids function as a cushion even when the laminate is pressurized, and the laminate can thus be adjusted to have arbitrary dimensions within a range where the voids are not eliminated, i.e., the lamination pitch can be adjusted to an arbitrary value. The porosity is calculated by the following formula from a measured volume of the laminate (area×thickness) and the theoretical volume of the laminate (weight/density):

(Measured volume of laminate−Theoretical volume of laminate)/Theoretical volume of laminate×100

When the area of the laminate is constant, the porosity is calculated by the following formula from a measured thickness of the laminate and the theoretical thickness of the laminate (weight/density/area):

(Measured thickness of laminate−Theoretical thickness of laminate)/Theoretical thickness of laminate×100

The porosity of the scintillator layers after the heating is preferably 30% by volume or lower. When the porosity is higher than this range, the filling rate of the scintillator decreases, and the brightness is thus reduced.

As means for providing voids inside the scintillator layer and the non-scintillator layer, for example, air bubbles may be incorporated thereto in the process of producing the scintillator layer or the non-scintillator layer, or hollow polymer particles may be added thereto. Meanwhile, even when the scintillator layer or the non-scintillator layer has irregularities on the surface, the same effects can be attained since voids are formed at contact interface of these layers. As means for providing irregularities on a surface of the scintillator layer or the non-scintillator layer, for example, an irregularity-forming treatment such as a blast treatment or an emboss treatment may be performed on the layer surface, or a filler may be contained in the layer to form irregularities on the surface. In cases where the scintillator layer is formed by applying a composition containing the scintillator particles and the adhesive resin onto a polymer film, irregularities can be formed on the surface of the scintillator layer, and voids can be provided at the contact interface between the scintillator layer and the polymer film. The size of the irregularities can be arbitrarily adjusted by controlling the particle size and dispersibility of the filler. The resulting laminate block is sliced to have a predetermined thickness.

The manufactured laminate which does not have an inclined structure is bent in an arc shape so as to have a predetermined lamination angle in a concentric circle. During bending, in order to prevent the lamination pitch from fluctuating, a temporary support body may be provided through an adhesive on one surface or both surfaces of the laminate side.

A pair of upper and lower bending jigs is commonly used for bending. Between the upper and lower bending jigs, voids are provided so as to have a predetermined arc shape or sector shape, and after the laminate is mounted, pressure is applied as required between the upper and lower bending jigs, thereby bending the laminate. As the jig, a mold or frame such as silicon or Teflon is commonly used.

The bent laminate (bending laminate) may be subjected to a heat treatment in a state of being fixed to the jig. This solidifies the laminate in a bent state. For the heat treatment, the same conditions as the above-described thermocompression are adopted. After the heating treatment, a string of the arc which is concentric from the radiation source and a plane parallel to the string are cut so that the thickness of the laminate is a predetermined thickness. The cutting method is not particularly restricted, but cutting may be performed by slicing with a wire or a knife, or scraping may be performed by machining cutting, polishing, etching, or the like so as to have a predetermined thickness.

In the laminate provided with the inclined structure in this manner, if required, a support may be attached to the radiation incident side or the opposite side, in order to maintain the lamination structure. As the support, a material having both X-ray transmittance and rigidity is preferred, and for example, a carbon fiber reinforced resin (CFRP) or an amorphous carbon sheet can be used. The attachment with the support may be via an adhesive layer composed of a known adhesive resin or may be directly attached to a detector without using the support.

Detector

In the present invention, a detector which detects light emitted from a scintillator layer upon receiving radiation is used with the scintillator composed of the laminate having the inclined structure. The detector is provided on the emission side or the incidence side of radiation.

In the detector, the X-ray from the outside is converted into light by the scintillator layer, and the light is converted into an electrical signal by the detector and at the same time is in a state of capable of being output to the outside in a form associated with position information.

The detector used in the present invention has a role of converting light into an electric signal and outputting the electric signal to the outside, and the configuration is not particularly restricted as long as a conventionally known detector can be used; however, the detector usually has a form in which a substrate, an image signal output layer, and a photoelectric conversion element are laminated in this order.

Among these constituents, the photoelectric conversion element has a function of absorbing light generated by the scintillator layer and converting it into the form of an electric charge. The photoelectric conversion element may take any specific structure as long as it has such a function. For example, the photoelectric conversion element used in the present invention can be constituted by a transparent electrode, a charge generation layer that is excited by incident light to generate an electric charge, and a counter electrode. The transparent electrode, the charge generation layer, and the counter electrode may all be conventionally known ones. Further, the photoelectric conversion element used in the present invention may be constituted by an appropriate photosensor, for example, plural photodiodes that are two-dimensionally arranged, or a two-dimensional photosensor such as a charge coupled device (CCD) or a complementary metal-oxide-semiconductor (CMOS) sensor. Since these transmit X-rays, even in the case in which the detector is provided on the irradiation side, there is less influence on the light emitted from the scintillator.

In order to reduce the optical loss at the interface between the detector and the scintillator panel, it is preferred that the detector and the scintillator member be bonded with a transparent material having a refractive index of higher than 1.0 (air). A method of bonding the laminated scintillator panel and the photoelectric conversion panel is not particularly specified, but for example, an adhesive, a double-sided tape, a hot-melt sheet, or the like can be used.

According to the present invention, a scintillator panel which has high brightness and MTF and in which noise caused by, for example, X-ray vignetting is reduced can be obtained. Such a scintillator panel is capable of capturing a phase contrast image.

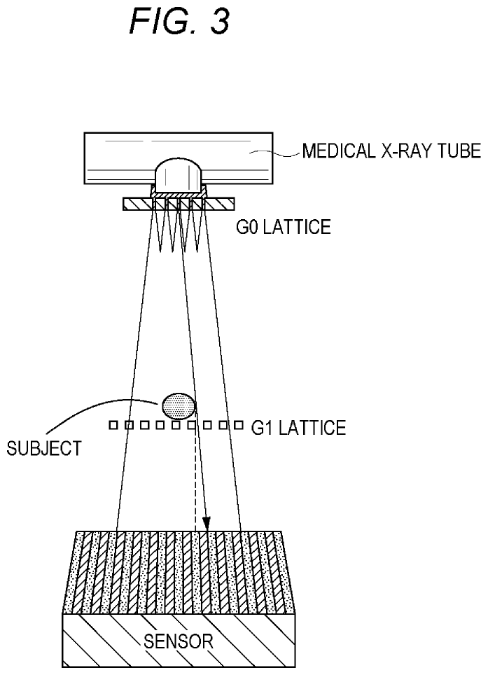

Therefore, the scintillator panel of the present invention can be suitably used in a Talbot system. FIG. 3 is a schematic structural view illustrating a Talbot scintillator including the scintillator panel according to the present invention.

The scintillator panel of the present invention already has the function of a G2 lattice and, therefore, can be used with a G2 lattice being removed from a device. For example, JP 2016-220865A, JP 2016-220787A, JP 2016-209017A, and JP 2016-150173A provide detailed descriptions of Talbot imaging devices.

According to the present invention, since the radiation is incident in parallel to the shape of the scintillator layer and the non-scintillator layer even at the end, vignetting is suppressed at the end, thereby capable of obtaining a scintillator panel having less signal blur and high image characteristics.

Therefore, the scintillator panel of the present invention can be used in high-voltage photographing and thus enables to capture images of thick subjects, such as thoracoabdominal parts, femoral parts, elbow joints, knee joints, and hip joints.

Conventionally, MRI is mainly used for image diagnosis of cartilages; however, there are drawbacks in that the imaging cost is high because of the use of large-scale equipment and a long time is required for the imaging. On the other hand, according to the present invention, X-ray images of soft tissues such as cartilages, muscle tendons, and ligaments as well as visceral tissues can be obtained at a lower cost in a speedier manner. Therefore, the present invention is expected to be widely applied to image diagnosis of orthopedic diseases, such as rheumatoid arthritis and knee osteoarthritis, and soft tissues including breast cancer.

Although embodiment of the present invention has been described and illustrated in detail, it is clearly understood that the same is by way of illustration and example only and not limitation, the scope of the present invention should be interpreted by terms of the appended claims.

What is claimed is:

1. A scintillator panel comprising: a laminate in which a scintillator layer and a non-scintillator layer are repeatedly laminated in a direction substantially parallel to a radiation incident direction, wherein the laminate has an inclined structure in which a lamination angle of each layer in the laminate is changed in a sector shape and extrapolated surfaces of each layer to a radiation source intersect on a single line.

2. The scintillator panel according to claim 1, wherein at least one of the scintillator layer and the non-scintillator layer contains an organic material having a modulus of elasticity less than 10 GPa.

3. A method of producing a scintillator panel including a laminate in which a scintillator layer and a non-scintillator layer are repeatedly laminated in a direction substantially parallel to a radiation incident direction, wherein the laminate has an inclined structure in which a lamination angle of each layer in the laminate is changed in a sector shape and extrapolated surfaces of each layer to a radiation source intersect on a single line, the method comprising:
repeatedly laminating the scintillator layer and the non-scintillator layer, and
bending the laminate so that the lamination angle of each layer of the laminate is changed in a sector shape.

4. The method of producing a scintillator panel according to claim 3, further comprising, after the bending of the laminate, fixing the bent structure.

5. The method of producing a scintillator panel according to claim 4, further comprising, after the fixing of the bent structure, performing slicing so that an upper surface and a lower surface of the laminate are parallel to each other.

6. A radiation conversion panel comprising the scintillator panel according to claim 1 and a photoelectric conversion panel arranged to face each other.

7. A Talbot imaging device using the radiation conversion panel according to claim 6.
